(19) United States
(12) Patent Application Publication
(10) Pub. No.: US 2009/0128808 A1
(43) Pub. Date: May 21, 2009

(54) METHOD FOR THE COMMUNICATION AND COMPARISON OF THE WHITENESS OF PAPER

(76) Inventor: Alec Stewart Tindal, (US)

Correspondence Address: Alec Tindal, 22 Thackray Court, Cornmill View, Leeds, LS18 5NJ, omitted

(21) Appl. No.: 11/940,333

(22) Filed: Nov. 15, 2007

(51) Int. Cl. G01J 3/42

(52) U.S. Cl. 356/319

(57) ABSTRACT

The instant invention relates to a process for the rating of optically brightened paper by visually assessing the paper to ensure that it is white, followed by measurement on a highly accurate single reference spectrophotometer to generate a simple rating, which can then be used to inform the consumer or end user of the whiteness level of the paper. The whiteness level is controlled during production by an audited quality system to ensure each sample of paper is identical in rating.

The present invention relates to a process for the comparison and communication of the whiteness level of white paper using as a basis a single special suitable calibrated instrument and existing state of the art software & hardware methods for whiteness determination, coupled with a system for ensuring the paper is white and not slightly coloured and then transposing the data acquired to produce a simple rating system that can be understood by a person not educated in colour physics who would like to purchase/use paper of a certain whiteness.

A high degree of whiteness is a desirable property of paper and adds value to the paper. In the case of high whiteness papers, the most important raw materials of the papermaking industry are naturally not as white as the finished paper. For example pulp which naturally absorbs blue light and therefore is slightly yellowish in colour and imparts a slightly duller appearance to the paper than is required in the final product, where that product is high white paper. Optical brighteners are used in the papermaking industry to compensate for the absorption of blue light by absorbing UV-light with a maximum wavelength of 350-380 nm and converting it into visible blue light with a maximum wavelength of 440 nm. Shading colours (Typically blue and violet) and fillers are also present in high white papers.

Various instruments are used to measure white paper today, produced by a variety of manufacturers. These instruments do not always correlate well with each other and calibration systems are different in different regions of the world. Different systems are used in different countries to measure the whiteness of the paper sheet. The following have all been used: ISO Brightness, GE Brightness, CIE Whiteness, Z-Brightness etc. For a full description of all the systems in use and the colour theory involved, please refer to http://mitglied.lycos.de/whiteness/ where there are many useful references.

Usually CIE Whiteness also defined at http://mitglied.lycos.de/whiteness/ is generally recognised as the best correlation with the human eye.

Surprisingly despite all of the efforts directed towards colour theory, calibration and instrumentation and whiteness measurement (See list of references Appendix 1), there is still a great deal of confusion at the consumer end. At the point of sale paper whiteness is conveyed to the customer in many different and confusing ways, for example see Table 1:

TABLE 1

| Method | Example | Advantages | Disadvantages |
|---|---|---|---|
| Descriptive | Bright, white | Easily | Not easy to make |
| words | paper | Understood | comparisons |
| CIE | CIE 167 | Can be | Not understood by |
| Whiteness | | measured | person without |
| | | | experience, calibration |
| | | | and instrument can |
| | | | affect the result |
| Brightness | Brightness | Can be | Methods vary from |
| | 105 | measured | region to region, |
| | | | instrumental and |
| | | | calibration standards |
| | | | also vary |
| Visual | Clear | Simple | Variations in lighting |
| | window in | | and the fact that some |
| | paper ream | | papers are wrapped in |
| | or clear | | opaque wrapping |
| | ream | | makes comparison |
| | packaging | | impossible |

Even where numbers are quoted it is well known by persons expert in the field that if the same paper is measured on a different instrument type in a different region and using a different calibration system then entirely different numbers will be generated, leading to confusion and a lack of meaning behind the numbers. For example, two paper with the same CIE Whiteness number are not necessarily the same whiteness when viewed by the human eye.

See also the following reference: Producing & measuring whiteness, Alec Tindal, PITA Annual conference Chemicals in Papermaking, G-mex, Manchester, October 1997 proceedings.

In actual fact, despite the cost, time and expertise invested in producing very high white paper, often it is sold with no distinction in the market place (no numbers and no description, or a very vague description), which highlights the limitations of all systems in use today. These issues are compounded by the fact that much of the paper bought today by consumers is purchased directly from catalogues or the internet where the paper can not be seen directly or compared, for this reason alone a system is required.

All measurements made must in addition be done under controlled precise conditions with respect to, sample size, illumination type and intensity, ultraviolet portion of the light, background colour, viewing angle etc. These conditions rarely if ever occur when the end user is viewing the paper in the desired conditions of use.

The price paid for paper is often higher purely because the whiteness level is higher, at the same time the value of the paper to the consumer is not being correctly determined at the point of sale. In general the higher the whiteness of paper the better the contrast of black ink therefore the words are easier to read, also colour prints made on high white paper can be brighter, which makes printed pictures stand out more. There is therefore a strong need for a system whereby all papers can be compared simply and yet professionally and their whiteness communicated in a simple way to non expert persons. Such a system should be simple to use for the consumer and yet technically sound and robust enough to be accepted by the paper industry.

Surprisingly, it has now been found that there is a method to enable the expertise in the field at the current state of the art to be fully utilized whilst at the same time facilitating a system that can be easily understood by all, resulting in the ability to compare white papers for whiteness and communicate their comparative whiteness.

Therefore an object of the instant invention is a method for ranking the whiteness of various papers by whiteness.

Said white paper preferably is of the type uncoated woodfree papers, however other types could also be included in this system. It is uncoated woodfree papers that are mostly distinguished in value by their whiteness and these papers are often the highest white papers on the market. Uncoated woodfree papers includes: photocopier paper, some uncoated ink-jet papers, uncoated office papers etc. Usually these papers have a substance of between 70-90 grammes per square metre, but often higher basis weights are found up to almost 300 grammes per square metre.

Optical brighteners (also called Fluorescent Brightening Agents) for paper are often triazinylamino-stilbene compounds as described in The Environmental Fate of Fluorescent Whitening Agents, Werthemann & Kaschig, Appita 1994 pp 33-43. These products absorb UV light and re-emit it as fluorescent blue light causing the paper to appear whiter.

The optically brightened paper may contain up to 0.6% (or more) of Optical Brightener by weight (based on active product). When the paper is measured using any typical spectrophotometer, the amount of UV light in the illumination source (the light striking the paper sheet) affects directly the fluorescence output of the optical brightening agent or agents present in the paper. The higher the UV light component the more the optical brightening agent fluoresces and the higher the number measured (whether it be Brightness, Whiteness etc).

The optically brightened paper may also contain other additives commonly employed in the papermaking industry. Examples of such additives include fillers, sizing agents (for example, rosin, starch, alkyl ketene dimer, alkenyl succinic anhydride), wet strength resins (for example, poly-aminoamide-epichlorohydrin resins), retention- and drainage aids (for example, poly-aluminium chloride, polydiallyldimethylammonium chloride), and shading dyes.

Often the cost of the added optical brightening agent is a significant part of the overall paper costs where the paper is of high whiteness. An increase of 10 points in CIE whiteness can double the cost of optical brightening agent required. In addition for high white papers speciality optical brightening agents are often needed and the whiteness is built up by adding optical brightening agent at the surface (Often at the size-press in the starch solution) as well as in the base sheet of the paper (added at the wet-end to the fibres), all of which can result in very high dosage levels (and costs) required for very high whiteness levels. For more information see Exploring the Effect of disulpho optical brightening agents on filler retention, Gauto, PIRA Fillers & Pigments for Papermakers proceedings, Lisbon, June 2005 and new Developments in Optical Brightening Agents, Tindal, Papier Aus Oesterreich 2/2001.

The following examples further serve to illustrate the invention.

### EXAMPLE 1

3 sheets of 80 gsm photocopier paper containing an optical brightening agent added to the fibres at the wet-end and a different optical brightening agent at the surface in the size-press starch solution, also containing shading colours and various other additives such as a carbonate filler, sizing agents, retention and drainage chemicals etc., were measured using typical spectrophotometers used in the paper industry. The results are shown in table 2.

TABLE 2

| Measurement instrument | | |
|---|---|---|
| manufacturer | CIE Whiteness | ISO Brightness |
| Paper A | | |
| Paper Manufacturers | 158 | 111 |
| calibrated instrument | | |
| Minolta | 165 | Not available |
| Autoelrepho | 176 | 119 |
| Paper B | | |
| Paper Manufacturers | 161 | 112 |
| calibrated instrument | | |
| Minolta | 169 | Not available |
| Autoelrepho | 182 | 121 |
| Paper C | | |
| Paper Manufacturers | 161 | 107 |
| calibrated instrument | | |
| Minolta | 165 | Not available |
| Autoelrepho | 178 | 116 |

It is clear from the results that the current methods of measuring paper whiteness are confusing and not easily understood, despite the fact that for each paper manufacturer the systems are in place to ensure that each sheet of paper is identical in whiteness to all others of the same grade and each spectrophotometer is calibrated and highly accurate at generating the correct data when used in the same way for each measurement.

It is clear that papers with similar brightness measurements according to the manufacturer can have completely different whiteness values when measured on other instruments and that there is often no correlation between instruments and measurement systems.

It is also clear that the end user or consumer can not be expected to have knowledge of the complicated mathematical equations and physical requirements of the measuring process involved to generate the numbers given.

Therefore a more simple system that can be easily understood and used to communicate the whiteness of the paper to the end user or consumer and yet at the same time utilizes a robust and state of the art measurement system and allows rigorous quality control to be maintained is proposed as follows:

A paper submitted for assessment would be first visually assessed by a professional with experience under standard lighting conditions to ensure that the paper is actually white and not blue or violet (the CIE Whiteness measurement system demands this anyway, although other systems do not). This is because blue or violet papers can generate high whiteness values in some instruments.

After the above stage the sheet of paper would be measured on a standard reference instrument. There would be only one such reference instrument, in order to make sure that all of the paper is measured and compared under exactly the same conditions. This instrument would be of a high technical standard, calibrated to at least one national standard and in a controlled atmosphere and in good working condition.

The measurement would generate a CIE Whiteness value (and other readings such as ISO Brightness, CIELAB values etc).

The paper would then be given a rating according to the example scale shown in table 3 below, where a higher number would be allocated to the highest white paper.

These values have been chosen from experience and serve as an example of the rating system, but the exact numbers could be changed.

TABLE 3

| | CIE Whiteness Measured |
|---|---|
| | by calibrated reference |
| Rating | Instrument |
| 10 | 180+ |
| 9 | 175+ |
| 8 | 170+ |
| 7 | 165+ |
| 6 | 160+ |
| 5 | 155+ |
| 4 | 150+ |
| 3 | 145+ |
| 2 | 130-145 |
| 1 | Under 130 |

Once the paper has been assessed and given a scale, the manufacturer must ensure that all paper made under the same trademark and product name and whiteness level is in fact identical in whiteness to the original sample supplied. This can be done by monitoring the colour and whiteness in the normal way using the manufacturer's conventional measurement systems providing these quality systems have been audited by an expert and are not changed, such that a spot check carried out on any sample of the paper produced is equivalent to the original paper sample measured and rated above.

The process would be repeated after one year in order to avoid that the whiteness of the paper drifts away from the original rating.

Consumers and end user can then easily compare papers (even those purchased over the internet) by comparing the rating values of different paper products, without a thorough knowledge of the colour physics involved.

### EXAMPLE 2

A person with no experience in paper whiteness measurement wishes to purchase paper of the highest whiteness in order to print a colour photograph on a typical ink jet printer at home with high contrast and bright colours.

Using the current systems in place the person searches internet sites, visits stores and collects the following data on the whiteness or brightness of four papers which are all suitable for his printing needs:

Paper 1: High White Paper

Paper 2: CIE Whiteness 167

Paper 3: Brightness 110

Paper 4: looked very white visually through the clear paper wrapping

Surprisingly, despite the information being supplied being totally accurate and in some cases requiring a great deal of quality control and colour measurement experience on behalf of the paper manufacturers, based on this information he is not able to make a decision which paper is the whitest.

Using the new rating system proposed the papers would be additionally rated as follows:

Paper 1: High White Paper, Whiteness Rating 7

Paper 2: CIE Whiteness 167, Whiteness Rating 9

Paper 3: Brightness 110, Whiteness Rating 10

Paper 4: Looked very white visually through the clear paper wrapping, Whiteness Rating 9

Based on the whiteness rating and the knowledge that all the papers were measured on the same instrument he is confidently able to purchase Paper 3 in the knowledge that it has the highest whiteness in comparison to the other papers evaluated.

1. Process for rating the whiteness of optical brightened paper composing a visual assessment, reference instrument measurement, system of rating and a quality control system.

2. Process according to claim 1 wherein the type of paper comprises optically brightened paper for photocopier, office, envelope, ink-jet, laser printer, label fine paper, letter paper or lightweight paperboard.

3. Process according to claim 2 wherein the paper is coated.

4. Process according to claim 1 where the paper is rated according to Table 3 above

5. Process according to claim 1 where the paper is rated according to a system similar to Table 3 above.

6. Process according to claim 1 where the reference instrument is a spectrophotometer and is calibrated to a national standard.

7. Process according to claim 1 where the rating scale used is as quoted in table 2.

8. Process according to claim 1 where a different rating scale is used.

9. Process according to claim 1 where the instrumental measurement phase is removed and the evaluation and rating of the paper is made through visual assessment.

10. Process according to claim 1 wherein any type of paper is rated for whiteness or brightness.

11. Optically brightened paper rated to a process according to any of the preceding claims.
